(19) United States
(12) Patent Application Publication
(10) Pub. No.: US 2015/0324045 A1
(43) Pub. Date: Nov. 12, 2015

(54) CURVED TOUCH DISPLAY DEVICE AND METHOD FOR FORMING THE SAME

(71) Applicant: InnoLux Corporation, Miao-Li County (TW)

(72) Inventors: Meng-Hui CHI, Miao-Li County (TW); Tung-Chang TSAI, Miao-Li County (TW); Hung-Sheng CHO, Miao-Li County (TW)

(21) Appl. No.: 14/695,668

(22) Filed: Apr. 24, 2015

(30) Foreign Application Priority Data
May 8, 2014 (TW) 103116352

(51) Int. Cl. G06F 3/041; B32B 37/10

(52) U.S. Cl. CPC G06F 3/0412; B32B 37/10; G06F 2203/04102; B32B 2457/206; B32B 2457/208

(57) ABSTRACT

An embodiment of the invention provides a curved touch display device including: a display panel having a display area and a non-display area; a touch panel disposed on the display panel, wherein the touch panel has a touch area and a peripheral area, and a light shielding layer is disposed in the peripheral area to shield the non-display area; a curved light-transmissive cover plate disposed on the touch panel and having a curved surface; and an optically clear adhesive layer disposed between the light shielding layer of the touch panel and the curved light-transmissive cover plate.

### CROSS REFERENCE TO RELATED APPLICATIONS

This Application claims priority of Taiwan Patent Application No. 103116352, filed on May 8, 2014, the entirety of which is incorporated by reference herein.

### BACKGROUND OF THE INVENTION

1. Field of the Invention

The present invention relates to a touch display device, and in particular it relates to a curved touch display device and a method for forming the same.

2. Description of the Related Art

Along with advances in digital technology, the variety of data-processing devices is growing at an amazing speed. A variety of multi-media devices are used to provide abundant digital information in our daily lives. In this trend of digital information, touch panels are applied in many devices.

Touch panels can be used in electronic products such as watches, cell phones, and display screens. For ergonomic reasons, a touch panel may be designed in a curved shape. However, the process for forming curved touch panels is not completely the same as the process for forming flat touch panels. Therefore, it is desirable to develop a fabrication process for forming curved touch panels and to improve the product yield of curved touch panels.

### BRIEF SUMMARY OF THE INVENTION

An embodiment of the invention provides a curved touch display device which includes: a display panel having a display area and a non-display area; a touch panel disposed on the display panel, wherein the touch panel has a touch area over the display area and a peripheral area over the non-display area, and a light shielding layer is disposed in the peripheral area to shield the non-display area; a curved light-transmissive cover plate disposed on the touch panel and has a curved surface; and an optically clear adhesive layer disposed between the light shielding layer of the touch panel and the curved light-transmissive cover plate.

An embodiment of the invention provides a method for forming a curved touch display device, which includes: providing a curved light-transmissive cover plate having a curved surface; providing a touch panel having a touch area, a peripheral area surrounding the touch area, and a light shielding layer located in the peripheral area; performing a rolling press process to bond the touch panel onto the curved surface; and bonding a display panel to the touch panel.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A-1F are cross-sectional views showing the steps of forming a curved touch display device in accordance with an embodiment of the present invention;

FIGS. 2A-2F are cross-sectional views showing the steps of forming a curved touch display device in accordance with another embodiment of the present invention;

FIG. 3 is a cross-sectional view of a curved touch display device in accordance with an embodiment of the present invention;

FIG. 4 is a cross-sectional view of a curved touch display device in accordance with another embodiment of the present invention;

FIG. 5 is a cross-sectional view of a curved touch display device in accordance with an embodiment of the present invention;

FIG. 6 is a cross-sectional view of a curved touch display device in accordance with an embodiment of the present invention;

FIG. 7 is a cross-sectional view of a curved touch display device in accordance with an embodiment of the present invention;

FIG. 8 is a cross-sectional view of a curved touch display device in accordance with an embodiment of the present invention;

FIG. 9 is a cross-sectional view of a curved touch display device in accordance with an embodiment of the present invention;

FIG. 10 is a cross-sectional view of a curved touch display device in accordance with an embodiment of the present invention;

FIG. 11 is a cross-sectional view of a curved touch display device in accordance with an embodiment of the present invention;

FIG. 12 is a cross-sectional view of a curved touch display device in accordance with an embodiment of the present invention;

FIG. 13 is a cross-sectional view of a curved touch display device in accordance with an embodiment of the present invention; and

FIG. 14 is a cross-sectional view of a curved touch display device in accordance with an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It should be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer, include embodiments where the first and second layers are in direct contact and those where one or more layers are interposing the first and second layers.

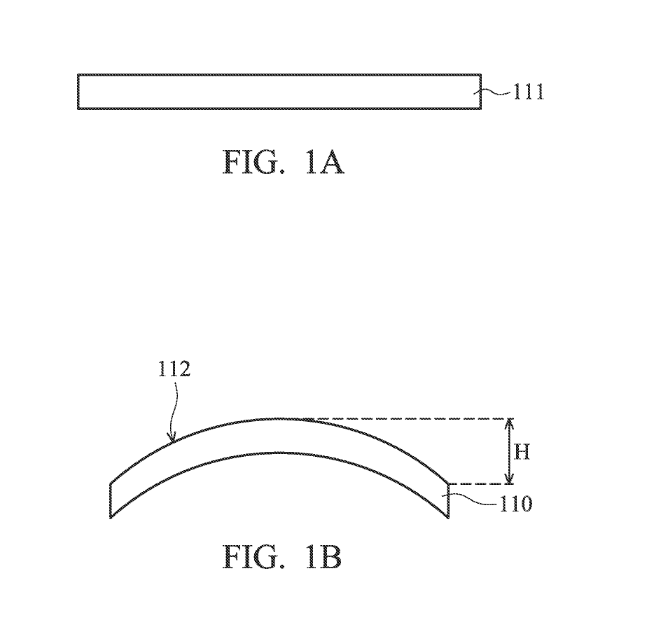

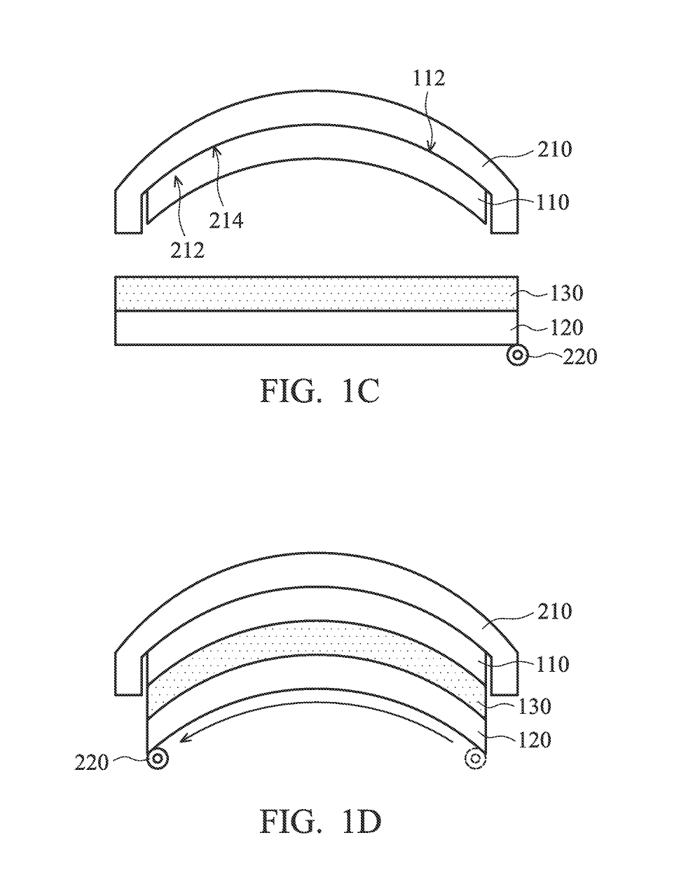

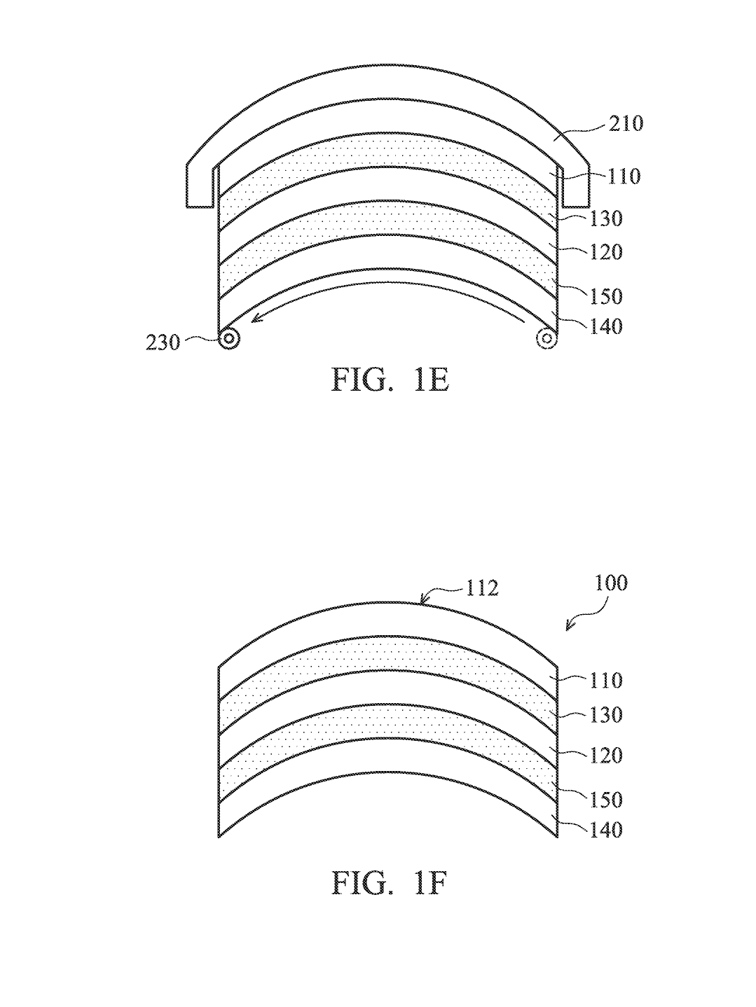

FIGS. 1A-1F are cross-sectional views showing the steps of forming a curved touch display device in accordance with an embodiment of the present invention. Referring to FIG. 1A, in the present embodiment, a light-transmissive cover plate 111 is optionally provided. The light-transmissive cover plate 111 includes plastic, glass, or another suitable transparent material.

Thereafter, referring to FIG. 1B, a thermoplastic molding process is performed on the light-transmissive cover plate 111 to form a curved light-transmissive cover plate 110. The curved light-transmissive cover plate 110 has a curvature greater than zero. In one embodiment, the curved light-transmissive cover plate 110 has a convex curved surface 112. The convex curved surface 112 may be a touch surface of the curved touch display device. A finger or another conductive object may directly contact the touch surface to perform a touch operation.

In one embodiment, the convex curved surface 112 has a radius of curvature ranging from 300 mm to 700 mm substantially. The convex curved surface 112 has a protrusion height H ranging from 2 mm to 10 mm substantially. In the present embodiment, the protrusion height H of the convex curved surface 112 is the difference in height between the highest point and the lowest point of the convex curved surface 112 when the curved light-transmissive cover plate 110 is disposed horizontally.

In another embodiment, the curved light-transmissive cover plate 110 is formed by filling a transparent fluid material (such as plastic or glass) into a mold with a curved recess (not shown) and solidifying the transparent fluid material, and the thermoplastic molding process is not needed.

Thereafter, referring to FIG. 1C, the curved light-transmissive cover plate 110 is optionally disposed in a recess 212 of a mold 210. The recess 212 has a curved bottom surface 214 corresponding to the convex curved surface 112 of the curved light-transmissive cover plate 110. Specifically, the curvature of the curved bottom surface 214 is equal to the curvature of the convex curved surface 112. In one embodiment, the convex curved surface 112 of the curved light-transmissive cover plate 110 is bonded to the curved bottom surface 214 of the recess 212 of the mold 210.

Thereafter, as shown in FIG. 1C, a touch panel 120 is provided. In the present embodiment, an optically clear adhesive layer 130 is formed on the touch panel 120. The optically clear adhesive layer 130 includes acrylic or another suitable transparent glue material. Afterwards, as shown in FIGS. 1C and 1D, the touch panel 120 is bonded onto the curved light-transmissive cover plate 110 by performing a rolling press process using a roller 220. The curved light-transmissive cover plate 110 is bonded to the touch panel 120 by the optically clear adhesive layer 130. In the rolling press process mentioned above, the mold 210 may support the curved light-transmissive cover plate 110. In one embodiment, the rolling press process is performed in a vacuum environment to reduce the probability of bubbles forming between the touch panel 120 and the curved light-transmissive cover plate 110.

Since the rolling press process can apply a uniform pressure to a curved object, the touch panel 120 is conformally bonded to the curved light-transmissive cover plate 110, and the formation of bubbles between the touch panel 120 and the curved light-transmissive cover plate 110 may be prevented.

Thereafter, as shown in FIG. 1E, a display panel 140 is provided. An optically clear adhesive layer 150 is optionally formed on the display panel 140. The display panel 140 is, for example, an organic light-emitting diode panel (OLED panel) or another suitable flexible display panel. Then, the display panel 140 is bonded onto the touch panel 120 by performing a rolling press process using a roller 230. The display panel 140 is bonded onto the touch panel 120 by the optically clear adhesive layer 150. In one embodiment, the rolling press process is performed in a vacuum environment to reduce the probability of bubbles forming between the touch panel 120 and the display panel 140. As shown in FIG. 1F, the mold 210 is removed. In this step, a curved touch display device 100 of the present embodiment is substantially formed.

Since the rolling press process can apply uniform pressure to a curved object, the display panel 140 is conformally bonded to the curved touch panel 120, and the formation of bubbles between the display panel 140 and the curved touch panel 120 may be prevented.

The manufacturing method of FIGS. 1A-1F may also be used to form a curved touch display device with a concave touch curved surface, and a detailed description is provided below.

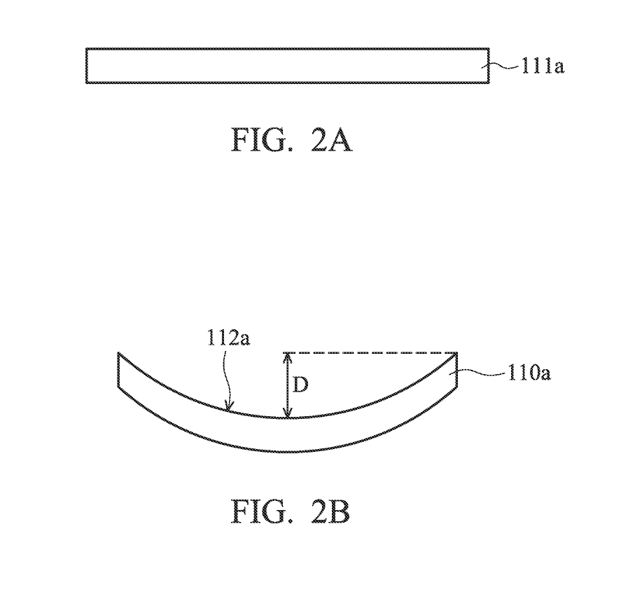

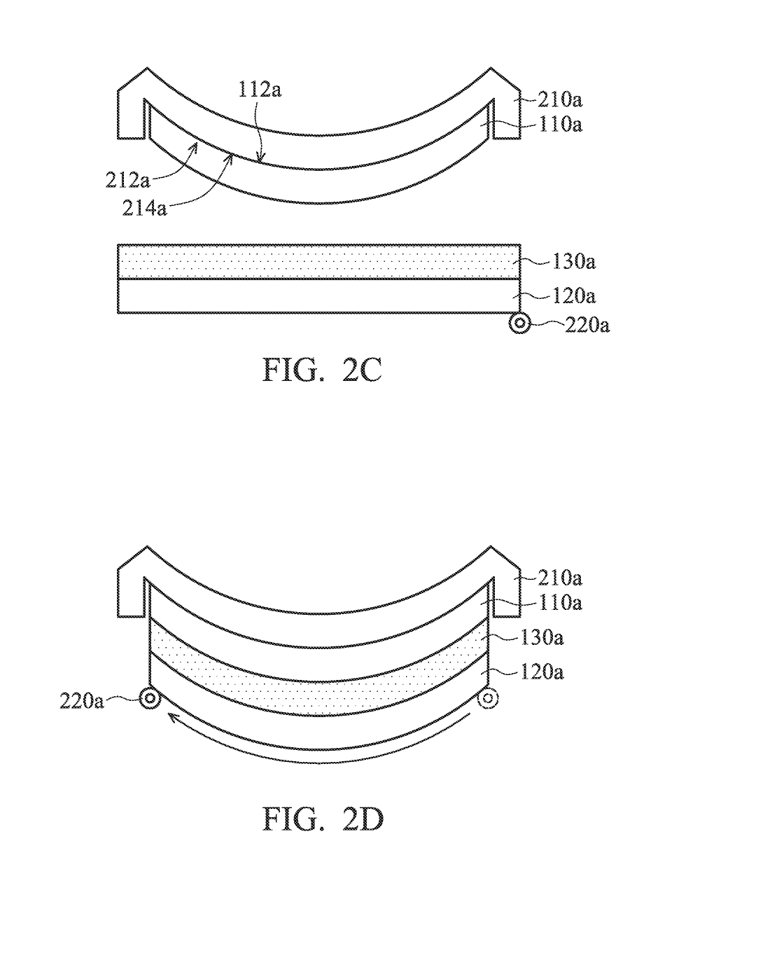

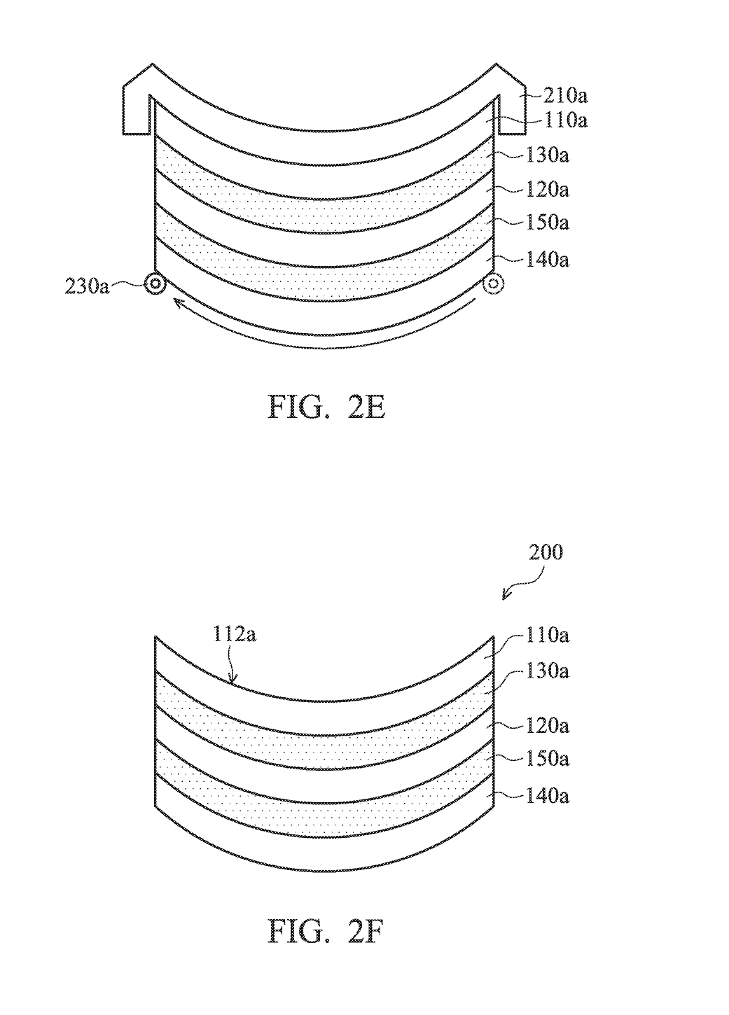

FIGS. 2A-2F are cross-sectional views showing the steps of forming a curved touch display device in accordance with another embodiment of the present invention. It should be noted that the embodiment of FIGS. 2A-2F is similar to the embodiment of FIGS. 1A-1F, except that the embodiment of FIGS. 2A-2F forms a curved touch display device with a concave touch curved surface. Therefore, in the embodiments of FIGS. 2A-2F and FIGS. 1A-1F, the same or similar reference numbers are used to designate elements made of the same or similar materials.

Referring to FIG. 2A, in the present embodiment, a light-transmissive cover plate 111a is optionally provided. Thereafter, referring to FIG. 2B, a thermoplastic molding process is performed on the light-transmissive cover plate 111a to form a curved light-transmissive cover plate 110a. The curved light-transmissive cover plate 110a has a curvature greater than zero. In one embodiment, the curved light-transmissive cover plate 110a has a concave curved surface 112a. The concave curved surface 112a may be a touch surface of the curved touch display device. A finger or another conductive object may directly contact the touch surface to perform a touch operation.

In one embodiment, the concave curved surface 112a has a radius of curvature ranging from 300 mm to 700 mm substantially. The concave curved surface 112a has a recess depth D ranging from 2 mm to 10 mm substantially. In the present embodiment, the recess depth D of the concave curved surface 112a is a difference in height between a highest point and a lowest point of the concave curved surface 112a when the curved light-transmissive cover plate 110a is disposed horizontally.

In another embodiment, the curved light-transmissive cover plate 110a is formed by filling a transparent fluid material (such as plastic or glass) into a mold with a curved recess (not shown) and solidifying the transparent fluid material, and the thermoplastic molding process is not needed.

Thereafter, referring to FIG. 2C, the curved light-transmissive cover plate 110a is optionally disposed in a recess 212a of a mold 210a. The recess 212a has a curved bottom surface 214a corresponding to the concave curved surface 112a of the curved light-transmissive cover plate 110a. Specifically, the curvature of the curved bottom surface 214a is equal to the curvature of the concave curved surface 112a. In one embodiment, the concave curved surface 112a of the curved light-transmissive cover plate 110a is bonded to the curved bottom surface 214a of the recess 212a of the mold 210a.

Then, as shown in FIG. 2C, a touch panel 120a is provided. In the present embodiment, an optically clear adhesive layer 130a is formed on the touch panel 120a. Afterwards, as shown in FIGS. 2C and 2D, the touch panel 120a is pressed onto the curved light-transmissive cover plate 110a by performing a rolling press process using a roller 220a. The curved light-transmissive cover plate 110a is bonded to the touch panel 120a by the optically clear adhesive layer 130a. In the rolling press process mentioned above, the mold 210a may support the curved light-transmissive cover plate 110a. In one embodiment, the rolling press process is performed in a vacuum environment to reduce a probability of forming bubbles between the touch panel 120a and the curved light-transmissive cover plate 110a.

Since the rolling press process can apply a uniform pressure to a curved object, the touch panel 120a is conformally bonded to the curved light-transmissive cover plate 110a, and the formation of bubbles between the touch panel 120a and the curved light-transmissive cover plate 110a may be prevented.

Thereafter, as shown in FIG. 2E, a display panel 140a is provided. An optically clear adhesive layer 150a is optionally formed on the display panel 140a. The display panel 140a is, for example, an organic light-emitting diode panel (OLED panel) or another suitable flexible display panel. Then, the display panel 140a is bonded onto the touch panel 120a by performing a rolling press process using a roller 230a. The display panel 140a is bonded onto the touch panel 120a by the optically clear adhesive layer 150a. In one embodiment, the rolling press process is performed in a vacuum environment to reduce the probability of bubbles forming between the touch panel 120a and the display panel 140a. As shown in FIG. 2F, the mold 210a is removed. In this step, a curved touch display device 200 of the present embodiment is substantially formed.

It should be noted that, for simplicity, FIGS. 1C-1F and 2C-2F show the touch panels 120 and 120a roughly and do not show detailed structures of the touch panels 120 and 120a. In embodiments of the present invention, there may be different kinds (or structures) of touch panels 120 and 120a, and the detailed description is provided as follows.

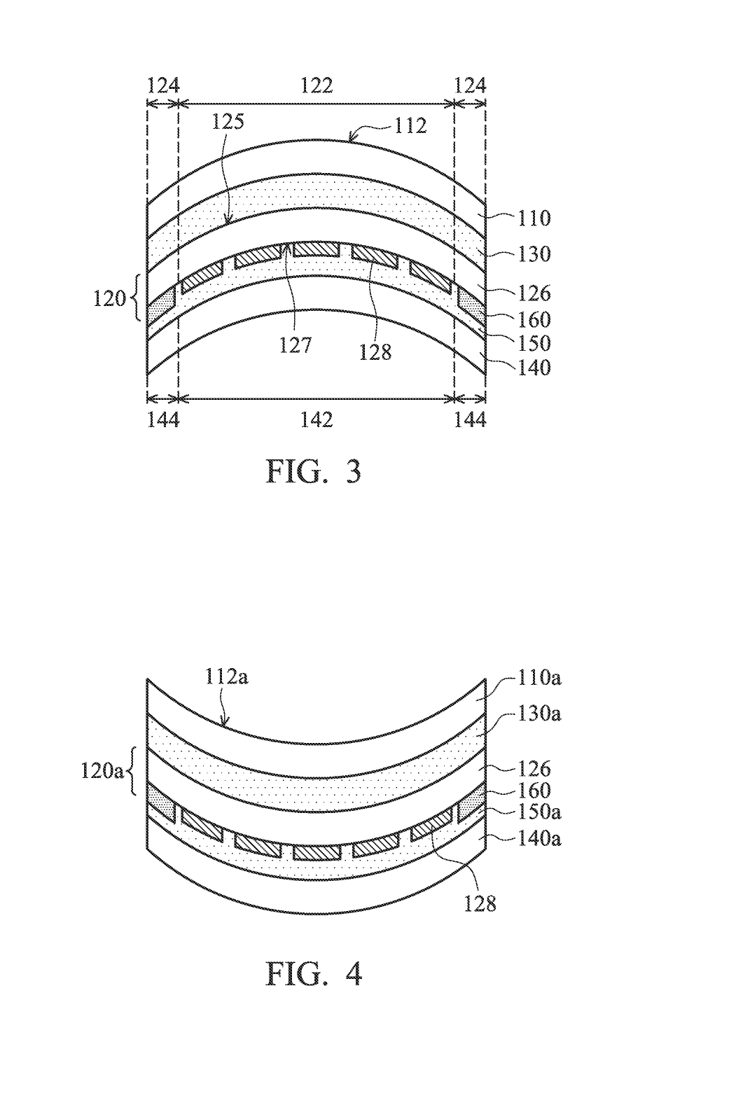

FIG. 3 is a cross-sectional view of a curved touch display device in accordance with an embodiment of the present invention. FIG. 3 shows a kind of touch panel 120 of the curved touch display device 100 of FIG. 1F. In the present embodiment, the display panel 140 has a display area 142 and a non-display area 144. A plurality of pixel electrodes (not shown) is disposed in the display area 142. A peripheral circuit (not shown) is disposed in the non-display area 144. The non-display area 144, for example, surrounds the display area 142.

The touch panel 120 includes a touch area 122 and a peripheral area 124. The peripheral area 124, for example, surrounds the touch area 122. In the present embodiment, the touch area 122 is positioned over the display area 142, and the peripheral area 124 is positioned over the non-display area 144. In the present embodiment, the touch panel 120 includes a substrate 126 and a touch electrode layer 128. The substrate 126 may have a surface 125 and a surface 127. The surface 125 faces the curved light-transmissive cover plate 110. The surface 127 faces the display panel 140. The touch electrode layer 128 is located on the substrate 126 and in the touch area 122. The touch electrode layer 128 may include X-axial sense lines and Y-axial sense lines.

In the present embodiment, a light shielding layer 160 is formed on the substrate 126 and in the peripheral area 124 to shield the peripheral circuit in the non-display area 144 of the display panel 140. The light shielding layer 160 includes ink or another suitable opaque material. It should be noted that the present embodiment forms the light shielding layer 160 on the substrate 126, not on the light-transmissive cover plate 111 (as shown in FIG. 1A), which prevents damage to the light shielding layer 160 during performing the thermoplastic molding process on the light-transmissive cover plate 111 to form the curved light-transmissive cover plate 110. Therefore, the yield of the process is improved.

In the present embodiment, the manufacturing method of the touch panel 120 includes: providing the substrate 126; forming the touch electrode layer 128 on the substrate 126 and in the touch area 122; and forming the light shielding layer 160 on the substrate 126 and in the peripheral area 124. In the present embodiment, the optically clear adhesive layer 130 is disposed between the light shielding layer 160 and the curved light-transmissive cover plate 110.

As shown in FIG. 3, in the present embodiment, the touch panel 120 is attached onto the curved light-transmissive cover plate 110 with the convex curved surface 112. In other embodiments, as shown in FIG. 4, a structure, which is the same as or similar to the touch panel 120 of FIG. 3, (such as the touch panel 120a) is attached to the curved light-transmissive cover plate 110a with the concave curved surface 112a. In the embodiment of FIG. 4, the optically clear adhesive layer 130a is disposed between the light shielding layer 160 and the curved light-transmissive cover plate 110a.

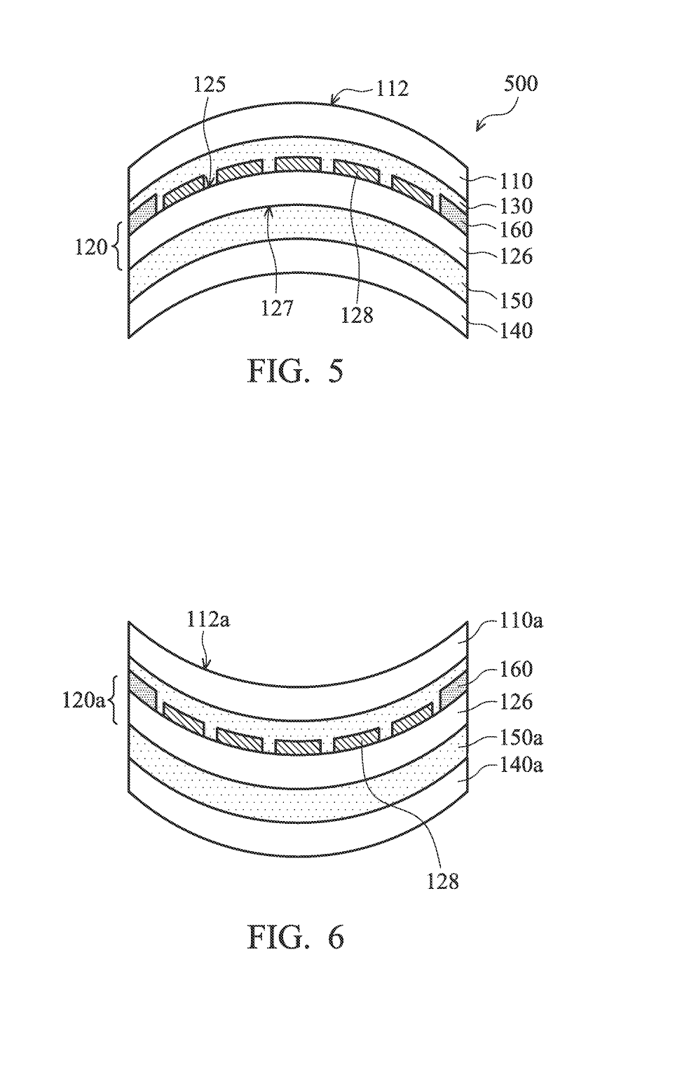

As shown in FIG. 3, in the present embodiment, the light shielding layer 160 and the touch electrode layer 128 are both located on the surface 127. In one embodiment, as shown in FIG. 5, the light shielding layer 160 and the touch electrode layer 128 are both located on the surface 125. As shown in FIG. 6, a structure, which is the same as or similar to the touch panel 120 of FIG. 5, (such as the touch panel 120a) is attached to the curved light-transmissive cover plate 110a with the concave curved surface 112a.

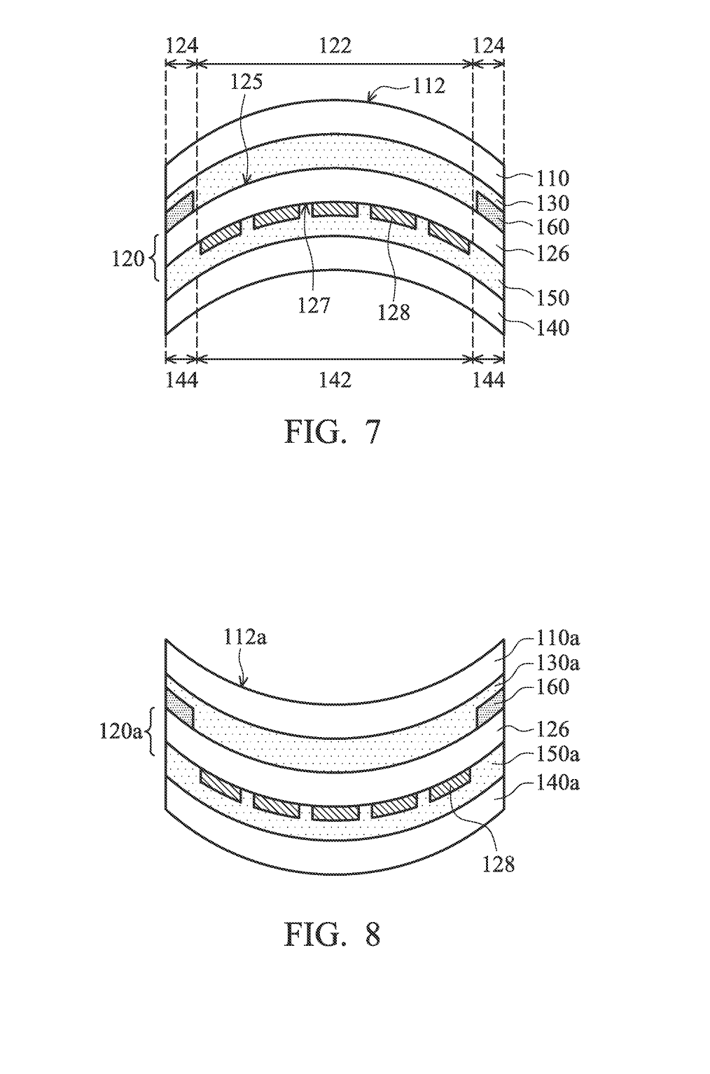

In another embodiment, as shown in FIG. 7, the light shielding layer 160 and the touch electrode layer 128 are located on the surfaces 125 and 127, respectively. The light shielding layer 160 and the touch electrode layer 128 are located in the peripheral area 124 and the touch area 122, respectively. As shown in FIG. 8, a structure, which is the same as or similar to the touch panel 120 of FIG. 7, (such as the touch panel 120a) is attached to the curved light-transmissive cover plate 110a with the concave curved surface 112a.

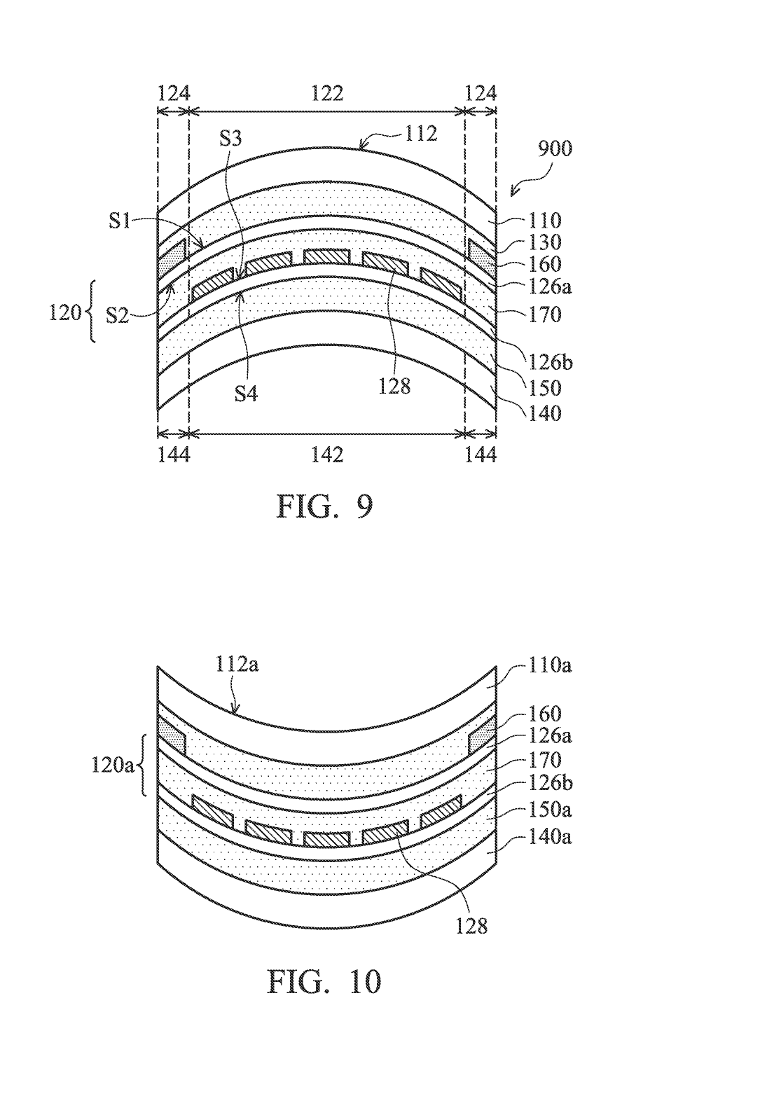

FIG. 9 is a cross-sectional view of a curved touch display device in accordance with an embodiment of the present invention. As shown in FIG. 9, a curved touch display device 900 of the present embodiment is similar to the curved touch display device 500 of FIG. 5, except that the touch panel 120 of the curved touch display device 900 of the present embodiment has two substrates 126a and 126b. The light shielding layer 160 and the touch electrode layer 128 are located on the substrates 126a and 126b, respectively.

Specifically, the touch panel 120 of the present embodiment has substrates 126a and 126b, a touch electrode layer 128, and an optically clear adhesive layer 170 between the substrates 126a and 126b. The substrate 126a has a surface 51 and a surface S2. The surface 51 faces the curved light-transmissive cover plate 110. The surface S2 faces the display panel 140. The substrate 126b has a surface S3 and a surface S4. The surface S3 faces the curved light-transmissive cover plate 110. The surface S4 faces the display panel 140. The light shielding layer 160 is located on the surface 51 and in the peripheral area 124. The touch electrode layer 128 is located on the surface S3 and in the touch area 122.

As shown in FIG. 9, in the present embodiment, the touch panel 120 is attached onto the curved light-transmissive cover plate 110 with the convex curved surface 112. In other embodiments, as shown in FIG. 10, a structure, which is the same as or similar to the touch panel 120 of FIG. 9, (such as the touch panel 120a) is attached onto the curved light-transmissive cover plate 110a with the concave curved surface 112a.

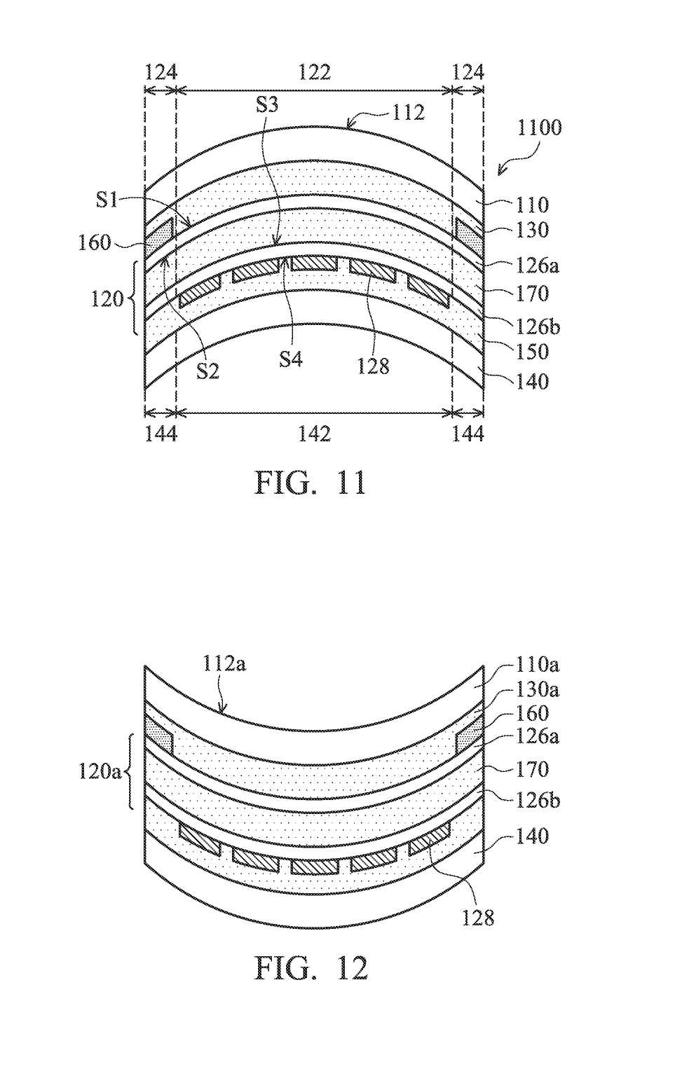

FIG. 11 is a cross-sectional view of a curved touch display device in accordance with an embodiment of the present invention. As shown in FIG. 11, the curved touch display device 1100 of the present embodiment is similar to the curved touch display device 900 of FIG. 9, except that the touch electrode layer 128 of the curved touch display device 1100 of the present embodiment is located on the surface S4 of the substrate 126b.

As shown in FIG. 11, in the present embodiment, the touch panel 120 is attached onto the curved light-transmissive cover plate 110 with the convex curved surface 112. In other embodiments, as shown in FIG. 12, a structure, which is the same as or similar to the touch panel 120 of FIG. 11, (such as the touch panel 120a) is attached onto the curved light-transmissive cover plate 110a with the concave curved surface 112a.

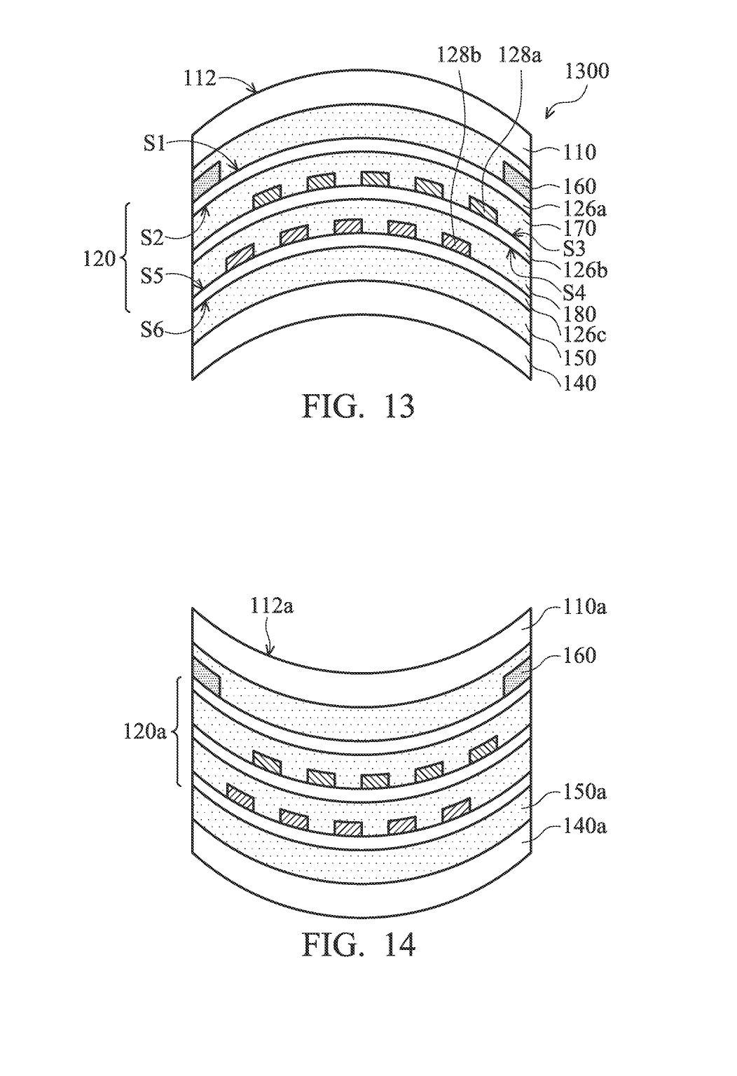

FIG. 13 is a cross-sectional view of a curved touch display device in accordance with an embodiment of the present invention. As shown in FIG. 13, a curved touch display device 1300 of the present embodiment is similar to the curved touch display device 900 of FIG. 9, except that the touch panel 120 of the curved touch display device 1300 of the present embodiment has three substrates 126a, 126b, and 126c, two optically clear adhesive layers 170 and 180, and two touch electrode layers 128a and 128b.

Specifically, the optically clear adhesive layer 180 is located between the substrates 126b and 126c to bond the substrate 126b to the substrate 126c. The substrate 126c has a surface S5 and a surface S6. The surface S5 faces the curved light-transmissive cover plate 110. The surface S6 faces the display panel 140. The touch electrode layer 128a is disposed on the surface S3 of the substrate 126b. The touch electrode layer 128b is disposed on the surface S5 of the substrate 126c. The touch electrode layers 128a and 128b includes, for example, sense lines arranged in an X-axis direction and sense lines arranged in a Y-axis direction, respectively.

As shown in FIG. 13, in the present embodiment, the touch panel 120 is attached onto the curved light-transmissive cover plate 110 with the convex curved surface 112. In other embodiments, as shown in FIG. 14, a structure, which is the same as or similar to the touch panel 120 of FIG. 13, (such as the touch panel 120a) is attached onto the curved light-transmissive cover plate 110a with the concave curved surface 112a.

As described above, in the present invention, the touch panel is conformally bonded to the curved light-transmissive cover plate by performing a rolling press process. Therefore, the touch panel is closely bonded to the curved light-transmissive cover plate, which prevents the formation of bubbles between the touch panel and the curved light-transmissive cover plate. The present invention forms the light shielding layer on the touch panel, not on the light-transmissive cover plate, which prevents the damage of the light shielding layer during performing the thermoplastic molding process on the light-transmissive cover plate to form the curved light-transmissive cover plate. Therefore, the yield of the process is improved.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A curved touch display device, comprising:
a display panel having a display area and a non-display area;
a touch panel disposed on the display panel, wherein the touch panel has a touch area over the display area and a peripheral area over the non-display area, and a light shielding layer is disposed in the peripheral area to shield the non-display area;
a curved light-transmissive cover plate disposed on the touch panel and having a curved surface; and
an optically clear adhesive layer disposed between the light shielding layer of the touch panel and the curved light-transmissive cover plate.

2. The curved touch display device as claimed in claim 1, wherein the touch panel comprises a substrate and a touch electrode layer, the touch electrode layer is located on the substrate and in the touch area, and the light shielding layer is located on the substrate.

3. The curved touch display device as claimed in claim 2, wherein the light shielding layer and the touch electrode layer are both located on a first surface of the substrate.

4. The curved touch display device as claimed in claim 2, wherein the substrate has a first surface and a second surface opposite to the first surface, and the light shielding layer and the touch electrode layer are located on the first surface and the second surface, respectively.

5. The curved touch display device as claimed in claim 1, wherein the touch panel electrode layer is located on the first substrate and in the touch area, and the light shielding layer is located on the second substrate.

6. The curved touch display device as claimed in claim 1, wherein the touch panel comprises a first substrate, a second substrate, a third substrate, a first touch electrode layer, and a second touch electrode layer, the first touch electrode layer is located on the first substrate and in the touch area, the second touch electrode layer is located on the second substrate and in the touch area, and the light shielding layer is located on the third substrate.

7. The curved touch display device as claimed in claim 1, wherein the curved surface has a radius of curvature ranging from 300 mm to 700 mm substantially.

8. The curved touch display device as claimed in claim 1, wherein the curved surface has a recess depth or a protrusion height ranging from 2 mm to 10 mm substantially.

9. A method for forming a curved touch display device, comprising:
providing a curved light-transmissive cover plate having a curved surface;
providing a touch panel having a touch area, a peripheral area surrounding the touch area, and a light shielding layer located in the peripheral area;
performing a rolling press process to bond the touch panel onto the curved surface; and
bonding a display panel to the touch panel.

10. The method for forming a curved touch display device as claimed in claim 9, further comprising:
forming an optically clear adhesive layer between the light shielding layer of the touch panel and the curved light-transmissive cover plate.
